(19) United States
(12) Patent Application Publication
(10) Pub. No.: US 2024/0181984 A1
(43) Pub. Date: Jun. 6, 2024

(54) CURTAIN AIRBAG AND CURTAIN AIRBAG DEVICE

(71) Applicant: JOYSON SAFETY SYSTEMS JAPAN G.K., Echi-gun, Shiga (JP)

(72) Inventor: Ryosuke NAKANISHI, Shiga (JP)

(73) Assignee: JOYSON SAFETY SYSTEMS JAPAN G.K., Echi-gun, Shiga (JP)

(21) Appl. No.: 18/553,256

(22) PCT Filed: Mar. 4, 2022
(86) PCT No.: PCT/JP2022/009318

§ 371 Date: Sep. 29, 2023

(30) Foreign Application Priority Data
Apr. 5, 2021 (JP) 2021-064280

(51) Int. Cl. B60R 21/232; B60R 21/2338

(52) U.S. Cl. CPC B60R 21/232; B60R 21/2338; B60R 2021/23386

(57) ABSTRACT

A curtain airbag and a curtain airbag device in which a stress applied from a front tether to a curtain airbag main body portion when inflation and deployment is distributed. An externally attached panel is disposed outside a front portion of a panel on a vehicle outer side among panels constituting a curtain airbag main body portion. An upper edge and a lower edge of the externally attached panel are sewn to the panels by a linear coupling portion. An intermediate portion of a rear edge of the externally attached panel in an upper-lower direction is sewn to the panels by an annular coupling portion. A rear portion of a front tether is sewn to a front portion of the externally attached panel.

### CROSS-REFERENCE TO RELATED APPLICATIONS

The present application claims priority under 37 U.S.C. § 371 to International Patent Application No. PCT/JP2022/009318, filed on Mar. 4, 2022, which claims priority to and the benefit of Japanese Patent Application No. 2021-064280, filed on Apr. 5, 2021. The contents of these applications are hereby incorporated by reference in their entireties.

### TECHNICAL FIELD

The present invention relates to a curtain airbag that inflates and deploys along a window or the like of a side door at the time of a side collision or rollover of an automobile, and a curtain airbag device including the curtain airbag.

### BACKGROUND ART

As an airbag for restraining a head portion of an occupant in an automobile, there is a curtain airbag which is disposed in a vicinity of an intersecting corner portion between a ceiling portion and a side surface portion in an automobile compartment and is configured to be inflated along a window or the like of a side door by gas introduced from a gas introduction port.

In the automobile provided with the curtain airbag device, when the automobile is subjected to a side collision or rollover, the curtain airbag is inflated downward along a side surface (for example, a door or a pillar) in a vehicle compartment to restrain a head of an occupant and prevent the occupant from being thrown out of the vehicle when the window is open.

Patent Literature 1 discloses a curtain airbag including a curtain airbag main body and a front strap connecting a front end side of the curtain airbag main body and a front pillar (A pillar). In Patent Literature 1, a rear end side of the front strap is sewn to a side surface portion of the curtain airbag main body.

In the curtain airbag of Patent Literature 1, when the curtain airbag is inflated and deployed, a stress tends to concentrate on a vicinity of a sewn portion on the rear end side of the front strap in a panel (basic fabric) constituting the curtain airbag main body.
Patent Literature 1: JP2012-20719A

### SUMMARY OF INVENTION

An object of the present invention is to provide a curtain airbag and a curtain airbag device in which a stress applied from a front tether to a curtain airbag main body portion when inflation and deployment is distributed.

A curtain airbag according to the present invention includes a curtain airbag main body portion, and a front tether extending forward from a front portion of the curtain airbag main body portion. An externally attached panel is disposed along a side surface on a vehicle outer side of the front portion of the curtain airbag main body portion, and a rear portion of the front tether is coupled to the externally attached panel.

In one aspect of the present invention, an upper edge and a lower edge of the externally attached panel are respectively coupled to an upper edge and a lower edge of the curtain airbag main body portion.

In one aspect of the present invention, an intermediate portion of a rear edge of the externally attached panel in an upper-lower direction is coupled to the curtain airbag main body portion.

In one aspect of the present invention, the intermediate portion of the rear edge of the externally attached panel in the upper-lower direction is coupled to the curtain airbag main body portion by an annular coupling portion.

In one aspect of the present invention, a front edge of the externally attached panel is positioned behind a front end of the curtain airbag main body portion.

A curtain airbag device according to the present invention includes the curtain airbag according to the present invention and an inflator configured to inflate the curtain airbag.

### Advantageous Effects of Invention

In the curtain airbag according to the present invention, a rear portion of the front tether is coupled only to the externally attached panel, and is not directly coupled to the curtain airbag main body portion. Therefore, an attachment position of the rear portion of the front tether is not limited to a distal end of the curtain airbag main body portion, and design flexibility of a length of the front tether and a distal end position of the curtain airbag main body portion increases. Further, a tether length can be made longer than in a case where the front tether is coupled to the distal end of the curtain airbag main body portion, and a load generated on the attachment portion of the tether can be reduced.

In one aspect of the present invention, portions of the externally attached panel along the upper edge and the lower edge are coupled to the curtain airbag main body portion. Therefore, a forward tensile load applied from the front tether to the externally attached panel is distributed over a wide range of the curtain airbag main body portion.

### BRIEF DESCRIPTION OF DRAWINGS

FIG. 1 is a side view of a curtain airbag according to an embodiment as viewed from a vehicle outer side before inflation.

FIG. 2 is a side view of the curtain airbag according to the embodiment as viewed from a vehicle compartment interior before inflation.

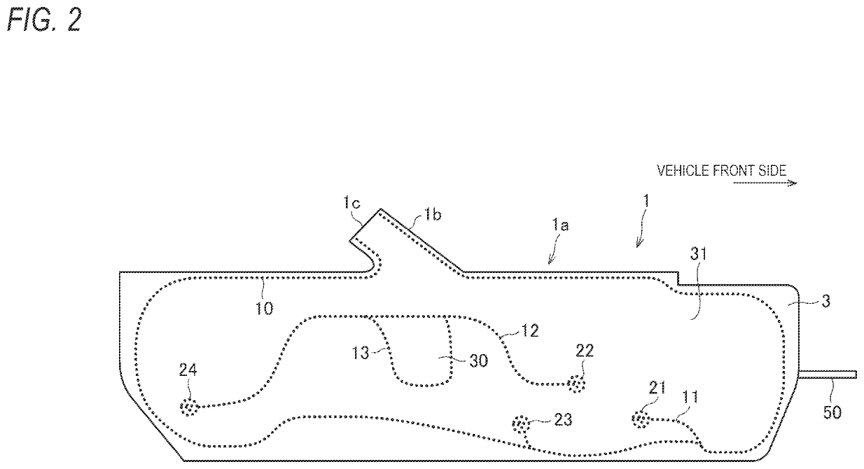

FIG. 3 is a cross-sectional view taken along a line III-III in FIG. 1 in a state in which the curtain airbag is inflated.

FIG. 4 is a cross-sectional view taken along a line IV-IV in FIG. 1 in the state in which the curtain airbag is inflated.

### DESCRIPTION OF EMBODIMENTS

Hereinafter, an embodiment will be described with reference to the drawings.

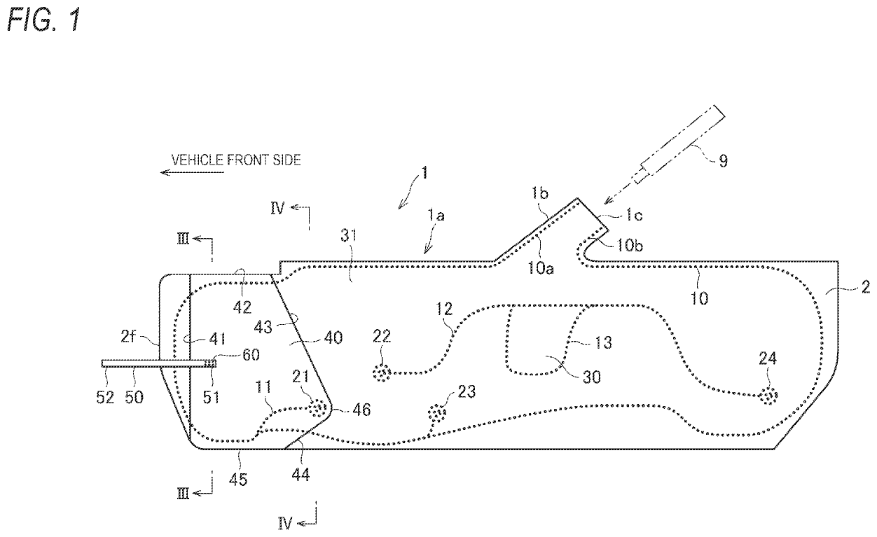

As shown in FIG. 1, a short tubular gas introduction portion 1b extending upward and obliquely rearward is provided at a central portion in a longitudinal direction of an upper edge of a curtain airbag main body portion 1a of a curtain airbag 1, and a tip end of the gas introduction portion 1b serves as a gas introduction port 1c. A tip end of an inflator 9 is inserted into the gas introduction port 1c and bound by a band (not shown). The inflator is fixed to a roof side portion of a vehicle body of an automobile by an attachment member (not shown).

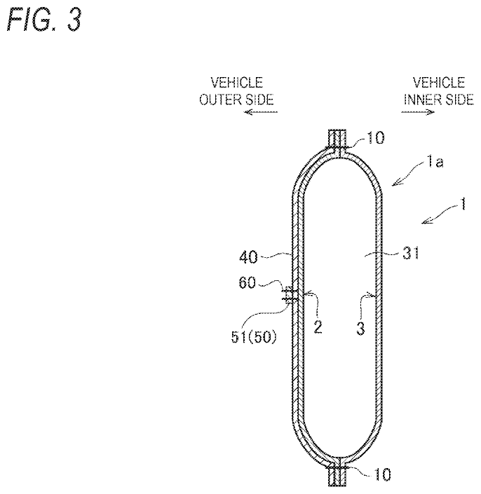

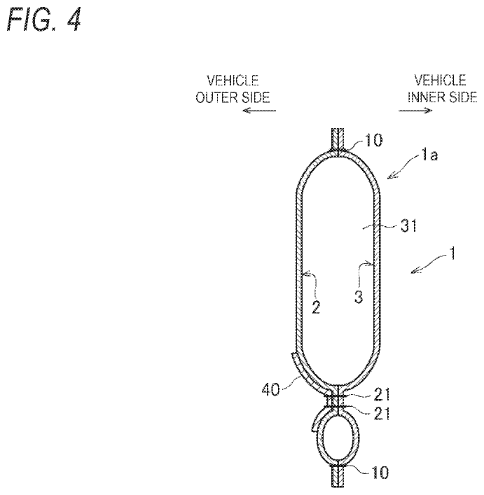

In the curtain airbag 1, two panels (basic fabrics) 2, 3 (FIGS. 3 and 4) having substantially the same shape are overlapped with each other, and the panels 2, 3 are coupled to each other by linear coupling portions 10 to 13 and annular coupling portions 21 to 24, thereby forming an inflatable portion (chamber) 31 and a non-inflatable portion 30. Although not shown, a plurality of patch cloths (basic fabrics) are sewn in the vicinity of the gas introduction portion 1b.

Each of the panels 2, 3 may be integrally integrated as a whole, or the curtain airbag main body portion 1a and the gas introduction portion may be separate bodies.

Instead of sewing the panels 2, 3, the curtain airbag may be formed by a one piece woven fabric which is woven in a tubular shape by a jacquard weaving machine or the like.

The curtain airbag may or may not have a silicon seal.

The linear coupling portions 10 to 13 and the annular coupling portions 21 to 24 are formed by a strong coupling method (for example, sewing with a high-strength sewing yarn, adhesion with an adhesive having high adhesive force, or welding) which airtightly couples the panels 2, 3 to each other and does not separate the panels 2, 3 from each other even when an internal pressure of the curtain airbag 1 increases to a design upper limit pressure.

The linear coupling portion 10 extends around the curtain airbag 1, and parts 10a, 10b thereof extend along a front edge and a rear edge of the gas introduction portion 1b.

The annular coupling portions 21 to 24 are disposed at intervals in a front-rear direction of the curtain airbag main body portion 1a. The annular coupling portion 21 is positioned behind front ends 2f of the panels 2, 3 by a predetermined distance.

The linear coupling portion 11 extends downward and forward from the annular coupling portion 21 and is connected to the linear coupling portion 10 at a lower edge portion. The linear coupling portion 12 extends so as to connect the annular coupling portions 22, 24. The linear coupling portion 13 extends downward from the linear coupling portion 12 in a substantially U-shape. An upper end of a front portion and an upper end of a rear portion of the linear coupling portion 13 are connected to the linear coupling portion 12.

An area surrounded by the linear coupling portions 12, 13 is the non-inflatable portion 30. An area other than the non-inflatable portion 30 in an inner area of the linear coupling portion 10 is the inflatable portion 31.

In this embodiment, an externally attached panel 40 is disposed on a vehicle outer side of a front portion of the curtain airbag 1. The externally attached panel 40 has a substantially five-sided shape having a front edge 41, an upper edge 42, a rear upper portion 43, a rear lower portion 44, and a lower edge 45.

The upper edge 42 and the lower edge 45 are respectively positioned so as to coincide with an upper edge and a lower edge of the panels 2, 3 of the curtain airbag 1. The front edge 41 extends in an upper-lower direction, and is positioned at the rear of the front ends 2f of the panels 2, 3 by a predetermined distance. In this embodiment, a lower end of the front edge 41 is positioned near intersections between front edges and lower edges of the panels 2, 3.

An intersection portion 46 between the rear upper portion 43 and the rear lower portion 44 of the externally attached panel 40 is positioned behind the annular coupling portion 21. Rear ends of the upper edge 42 and the lower edge 45 are positioned forward of the annular coupling portion 21.

Portions of the externally attached panel 40 along the upper edge 42 and the lower edge 45 are sewn (sewed together) to the panels 2, 3 by the linear coupling portion 10. In addition, the vicinity of the intersection portion 46 of the externally attached panel 40 is sewn (sewn together) to the panels 2, 3 by the annular coupling portion 21. Other portions of the externally attached panel 40 are not coupled to the panels 2, 3.

A rear end portion 51 of a front tether 50 is sewn and attached to a vicinity of the middle in the upper-lower direction of the front portion of the externally attached panel 40 by a coupling portion 60. The front tether 50 extends in the front-rear direction, and a front end thereof is positioned forward of front ends 2f of the panels 2, 3. A length of the front tether 50 is preferably 200 mm or more.

The curtain airbag main body portion 1a of the curtain airbag 1 is folded into an elongated shape by roll folding or the like so as to extend in the front-rear direction of the vehicle body, and is bound and maintained by a binding tool (not shown). The binding tool has a strength of breaking or unbinding when the curtain airbag 1 is inflated. The binding tools are disposed at a plurality of positions at intervals in a longitudinal direction of a folded body. The curtain airbag 1 is disposed along a vicinity of an intersection portion between a ceiling portion and a side surface portion of the automobile, and a front end portion 52 of the front tether 50 is attached to the front pillar (A pillar).

When the vehicle provided with the curtain airbag device configured as described above is subjected to a side collision or rollover, the inflator is operated to discharge gas, the gas is supplied to the curtain airbag 1, the curtain airbag 1 starts to inflate, a lower edge of a roof side garnish opens inward of a vehicle compartment, and the curtain airbag 1 inflates and deploys downward along a B pillar garnish and a side door glass.

In the present embodiment, a rear portion of the front tether 50 is sewn only to the externally attached panel 40, and is not directly coupled to the panels 2, 3. Therefore, when the curtain airbag 1 is inflated and deployed, the front tether 50 does not locally apply a large stress to the panels 2, 3.

In this embodiment, the portions of the externally attached panel 40 along the upper edge 42 and the lower edge 45 are coupled to the panels 2, 3 by the linear coupling portion 10. In addition, the annular coupling portion 21 is present behind the front tether 50, and the externally attached panel 40 is coupled to the panels 2, 3 by the annular coupling portion 21. Therefore, a forward tensile load applied from the front tether 50 to the externally attached panel 40 is distributed over a wide range of the curtain airbag main body portion 1a.

In order to deploy the roll-folded curtain airbag, it is necessary to secure a certain length or more of the front tether (hereinafter, referred to as a tether). In a case of a structure in the related art in which a tether is fastened to a distal end of the curtain airbag, when a tether length is excessively short, a large stress is generated in the front tether. Therefore, in the structure in the related art, a distal end position of an inflatable body of the curtain airbag is defined by the tether length.

On the other hand, in the present embodiment, since a distal end position of an inflatable body of the curtain airbag is not restricted by the tether length, the inflatable body of the curtain airbag can be set up to a vehicle front side, and it is easy to cope with small overlap.

According to the present embodiment, a degree of freedom in disposing a coupling position between the tether and the curtain airbag main body portion is increased. Therefore, the tether length can be made longer than that in the related art, thereby reducing the load applied to the tether during deployment.

In the present embodiment, the coupling portion between the front tether 50 and the externally attached panel 40 is the vehicle outer side of a side surface of the inflatable portion of the curtain airbag. As a result, a deploying position of the curtain airbag during deployment is on a vehicle inner side as compared with the related art. Therefore, at the time of a collision (oblique impact), the occupant can be restrained earlier.

The embodiment described above is an example of the present invention, and the present invention may be an aspect other than the aspect described above.

Although the present invention has been described in detail using a specific embodiment, it will be apparent to those skilled in the art that various changes can be made without departing from the spirit and the scope of the present invention.

The present application is based on a Japanese Patent Application No. 2021-064280 filed on Apr. 5, 2021, the entirety of which is incorporated herein by reference.

1. A curtain airbag comprising:
a curtain airbag main body portion; and
a front tether extending forward from a front portion of the curtain airbag main body portion,
wherein an externally attached panel is disposed along a side surface on a vehicle outer side of the front portion of the curtain airbag main body portion, and
wherein a rear portion of the front tether is coupled to the externally attached panel.

2. The curtain airbag according to claim 1,
wherein an upper edge and a lower edge of the externally attached panel are respectively coupled to an upper edge and a lower edge of the curtain airbag main body portion.

3. The curtain airbag according to claim 2,
wherein an intermediate portion of a rear side of the externally attached panel in an upper-lower direction is coupled to the curtain airbag main body portion.

4. The curtain airbag according to claim 3,
wherein the intermediate portion of the rear side of the externally attached panel in the upper-lower direction is coupled to the curtain airbag main body portion by an annular coupling portion.

5. The curtain airbag according to claim 1,
wherein a front edge of the externally attached panel is positioned behind a front end of the curtain airbag main body portion.

6. A curtain airbag device comprising:
the curtain airbag according to claim 1; and
an inflator configured to supply gas to the curtain airbag.
